(19) United States
(12) Patent Application Publication
(10) Pub. No.: US 2023/0059623 A1
(43) Pub. Date: Feb. 23, 2023

(54) DEVICE AND SYSTEM FOR COVERING A CUTTING GAP THAT IS ABLE TO BE CREATED BY A POWER TOOL, AND METHOD FOR EXTRACTING DUST FROM A WORKING AREA OF A POWER TOOL

(71) Applicant: Hilti Aktiengesellschaft, Schaan (LI)

(72) Inventors: Hans-Joerg RIEGER, Thueringen (AT); Urs ZOGG, Grabs (CH); Ansgar ZOLLER, Goefis (AT)

(21) Appl. No.: 17/796,681

(22) PCT Filed: Feb. 4, 2021
(86) PCT No.: PCT/EP2021/052620

§ 371 Date: Aug. 1, 2022

(30) Foreign Application Priority Data
Feb. 11, 2020 (EP) 20156538.9

(51) Int. Cl. B23Q 11/00

(52) U.S. Cl. CPC B23Q 11/0046; B28D 1/045

(57) ABSTRACT

A device for covering a cut gap which can be produced by a machine tool. The device can be connected to a dust suctioning device so that the dust produced while working with the machine tool can be removed from the working area of the machine tool using the dust suctioning tool. A second aspect of the invention relates to a system consisting of at least two proposed devices. Another aspect of the invention relates to a method for suctioning dust from a working region of a machine tool. The device includes sealing caps which can be connected to a dust suctioning device via suction connecting pieces. Furthermore, the sealing caps are used to seal the working area in which the working process of the machine tool is carried out.

The present invention relates to a device for covering a cutting gap that is able to be created by a power tool. The device can be connected to a dust extraction device such that the dust that arises while working with the power tool can be removed from the working area of the power tool with the aid of the dust extraction device. In a second aspect, the invention relates to a system made up of at least two proposed devices. In a further aspect, the invention relates to a method for extracting dust from a working area of a power tool.

### BACKGROUND

It is well known that dust arises when working on masonry, firm ground or concrete. Dust removal has become an important topic in the field of power tool development in recent years. In particular, dust is intended to be prevented from getting into the airways of power tool users because dust can result in health impairments there. In many methods that are known from the prior art, use is made of water or some other liquid fluid in order to bind the dust that arises when working with the power tool, in order for it to be possible to discharge it easily, in the bound state, from the working area of the power tool. In particular, this reduces the risk of dust flying freely around getting into the airways of the power tool user.

### SUMMARY OF THE INVENTION

However, it is also known that many jobs involving power tools should ideally not be carried out using water. This is the case in particular for areas on a building site in which water may result in subsequent damage or other impairments. Furthermore, the use of water frequently results in contamination. Although attempts have been made to keep this contamination low with devices and collecting devices provided specifically for this purpose, for example by collecting or extracting the dirty water, there is a strong desire by those skilled in the art for it to be possible to dispense with the use of water for binding dust when working with a power tool.

In order to avoid the use of water for binding dust on building sites, the prior art has proposed the use of extraction devices that can be attached or connected for example to a protective device for the tool of the power tool. However, it has been found that these extraction devices, which are often attached directly to the blade guard, are frequently incapable of extracting the dust that arises when working with the power tool to a satisfactory extent. Rather, it has frequently been found that, even when strong extraction devices are used, the dust can be extracted only insufficiently, since the dust is thrown for example out of the cutting gap produced when working with the power tool.

It is an object of the present invention to overcome above-described drawbacks and deficiencies of the prior art and to provide a device, a system and a method with which in particular a dry application of power tools is intended to be allowed. It should be possible in particular to dispense with the use of water for binding dust, in order in this way to leave behind cleaner building sites and for it to be possible to minimize the risk of subsequent water damage. It would be desirable for the invention not to make it harder to work with the power tool and for the invention to be easy to handle and to use. Furthermore, the invention should allow extraction of the dust arising when working with the power tool that is as effective and complete as possible, in order to keep the dust-related health risk for the power tool user as low as possible.

The present disclosure provides a device for covering a cutting gap that is able to be created by a power tool, in particular in a dry application, is provided. The device is characterized in that it covers the cutting gap in a working area of the power tool, wherein the device has means for connecting a device for dust extraction. According to the invention, it is preferred that the device more or less completely covers the cutting gap, such that particularly effective dust removal from the working area of the power tool can be achieved.

According to the invention, it is preferred that the device is a rail or a covering rail. Such a rail is used preferably in conjunction with a power tool and a dust extraction device in order to remove dust from a working area of the power tool. The expression “working area of the power tool” is not an unclear expression for a person skilled in the art. According to the invention, it means preferably the area of a substrate to be worked on, in which the tool of the power tool is in contact with the substrate, such as spatial areas in front of and behind this contact surface. The size of the working area can be dependent for example on the size of the power tool or of the tool that is used. For example, the expression “working area of the power tool” can encompass an area of about 50 cm in front of and about 50 cm behind the contact area between the tool and substrate. The resultant working area can then be for example about 1 m long. The working area can also have different dimensions, however.

The terms “front” and “behind” or “rear” do not represent unclear terms for a person skilled in the art because a person skilled in the art knows that the spatial direction “toward the front” can be defined by a working direction of the power tool, while the rear spatial region can define the area in the cutting gap that has already been worked on by the power tool and/or is located so to speak “behind” the power tool. According to the invention, it is preferred that both the spatial area or working area in front of the power tool and the spatial area and/or working area located behind the power tool are covered. In this case, the spatial area or working area behind the power tool can be configured without a closing cap or without a vacuuming device being connected. According to the invention, it is very particularly preferred that the length of a working area of the power tool corresponds to a length of the covering rail. According to the invention, this means preferably that the covering rail and the working area of the power tool have substantially similar lengths. According to the invention, it is particularly preferred to configure the covering rail to be as low as possible, in order not to sacrifice any cutting depth and thus to allow particularly deep cuts with the power tool.

According to the invention, it is preferred that the cuts that are created with the power tool are between 0.8 and 3 m long. However, cuts that have a length in a range from 0.1 to 10 m can also be created and covered with the proposed covering rail. In particular cut lengths of between 0 and 10 m and all values in between are preferred. In the case of long cuts that are for example longer than 2 m, use can preferably be made of a covering rail that has a length corresponding to the cut length. Alternatively, use can be made of a covering rail that can be assembled from a plurality of individual rails. For example, a cut with a length of 6 m can be covered with three rails that are each 2 m long. The individual cuts can—as in the example—be the same length or have different lengths. According to the invention, it may also be preferred to subdivide the cut to be created into a plurality of partial cuts and to create the cuts individually or separately from one another. In this case, the cuts that have already been created can be sealed off from the cut that is currently being created, in order to avoid any undesired escape of dust in the transition regions between the cuts.

The length of the covering rail is defined preferably by the two ends of the rail, which, according to the invention, are referred to preferably as the first and second end or front and rear end of the device. In particular, the length of the device corresponds substantially to the spacing of the two closing caps, which are provided on at least one of the two rail ends.

According to the invention, it is preferred that the power tool is a saw. In particular, it can be a wall saw designed to cut or cut through preferably vertical walls or to introduce cuts or gaps into such walls. In the context of the present invention, it may also be preferred to cut to size or to cut through parts or components of buildings to be erected, floors or ceilings. According to the invention, it may also be preferred that the power tool is a cut-off grinder. Preferably, the power tool has a motor, which can be supplied with energy with the aid of batteries, rechargeable batteries and/or via a connection to the public energy grid. The tool of the power tool may be preferably a saw blade or a cut-off wheel. For specific applications, the use of diamond-tipped saw blades or cut-off wheels may be preferred.

When working with the power tool in the substrate to be worked on, a cutting gap is created, which, according to the invention, can preferably also be referred to as a kerf. The substrate to be worked on can be preferably vertical walls, a level substrate, such as a floor surface or a ceiling. According to the invention, the work process with the power tool is preferably sawing, cutting or separation of the substrate to be worked on. The substrate to be worked on may encompass masonry, rock, concrete and/or other mineral substrates. When the substrate is being worked on, dust usually arises, which preferably contains particles of this substrate material.

According to the invention, the expression “dry application” should preferably be understood as meaning a sawing, cutting or separating process in which no water or other liquid fluid is used for binding dust. It is a particular advantage of the invention that the invention can provide a possibility of sawing or cutting without using water for binding dust, but the user of the power tool can still work in a substantially dust-free manner. Those skilled in the art previously assumed that either extraction devices directly on the protective device for the saw blade or cut-off wheel sufficed in order to achieve sufficient dust extraction or binding of dust, or that the use of water was necessary to prevent dust from getting into the user's airways. With the present invention, it is advantageously possible to dispense with the use of water, and so a clean and dry building site can be left behind. This is particularly advantageous when work is to be carried out at humidity-critical sites, at which the use of water can undesirably result in contamination or water damage.

According to the invention, it is preferred that the device has a first end and a second end. Preferably, the means for connecting a device for dust extraction are present at one end or at both ends of the covering rail. The closing caps can, however, also be present at any other conceivable position on the device. According to the invention, it is particularly preferred that the closing caps can be connected to the extraction duct in a removable or fixed manner. When the device is in the form of a covering rail which is used together with a power tool, it is possible for example for a front end of the device to be defined by the fact that it is located in a working direction of the power tool. In particular, the front end of the covering rail can be defined by the fact that the power tool moves toward the front end of the covering rail during the work process. The rear end of the device can be defined preferably by the fact that the work process starts at the rear end or in the vicinity of the rear end of the covering rail and that the power tool moves increasingly far away from the rear end during the work process. According to the invention, the device has means for connecting a device for dust extraction at one end or at both ends. According to the invention, these means are preferably also referred to as connection means. They may comprise for example suction nozzles. Preferably, they form closing caps for connecting a device for dust extraction. The device for dust extraction can preferably be a dust extraction device such as a vacuum cleaner or a dust collector. In other words, according to the invention, it may be preferred that the device has means for connecting a dust extraction device at a front end or at a rear end or at both ends. Preferably, the connection means are designed to establish a connection between the device and dust extraction device, i.e. the dust extraction device can be connected to the proposed covering rail preferably using the connection means. According to the invention, it is very particularly preferred that the connection for the vacuuming device is arranged in a region of the covering rail into which the dust is transported or thrown by the rotation of the tool of the power tool. As a result, particularly effective dust extraction as required is advantageously allowed.

According to the invention, it is preferred that the means for connecting a dust extraction device are designed to press the device onto a substrate to be worked on. In this way, the appearance of gaps or clearances, through which dust could escape and get into the user's airways, is advantageously avoided in a particularly effective manner. Furthermore, the holding of the covering rail down on the substrate to be worked on makes it possible for particularly precise work and straight cutting to be allowed. Preferably, the pressing function of the closing caps supports the formation of a substantially sealed dust space, which comprises preferably the cutting gap and is covered in an “upward” spatial direction by the proposed device. In particular, the closing caps allow effective sealing of this substantially sealed dust space at the ends of the covering rail.

According to the invention, it is particularly preferred that the connection means are designed to externally seal or close off the cutting gap at the ends. As a result, the dust is retained or enclosed in the kerf until it can be removed from the kerf with the aid of the dust extraction device. In particular, the sealing of the working area of the power tool makes it possible for the dust to be prevented from leaving the working area or the cutting gap and getting into the user's airways. According to the invention, it is very particularly preferred that the covering rail with its closing caps is designed to form a substantially closed dust space in which the dust can be collected until it can be extracted from the dust space with the aid of the dust extraction device.

In one configuration of the invention it is preferred that the device comprises a prefabricated gap for receiving a tool of the power tool during a work process. In other words, the device can have a prefabricated gap for receiving a saw blade or a cut-off wheel. In particular, the tool can move linearly forward and backward in the prefabricated gap, such that the power tool, or the tool, can advantageously also be guided by the prefabricated gap. When a device is used according to this configuration of the invention, the tool of the power tool can be guided particularly well within the device, such that a particularly accurate and straight cutting or separating result can be achieved. Furthermore, it is possible to reuse a covering rail with a prefabricated gap. Furthermore, on account of the pre-existing gap in the covering rail, it is possible to work particularly quickly, and so this configuration of the invention allows particularly efficient, time-optimized working with the power tool. In this embodiment of the invention, the covering rail can also be configured for example in a telescopic manner, in order to allow variable-length cuts to be covered.

According to the invention, it is preferred that the device comprises brushes that project into the prefabricated gap. As a result, an exit area for the dust through the prefabricated gap can be kept small and the amount of effectively escaping dust can be reduced even more considerably. According to the invention, it is preferred that the brushes consist of, or comprise, a heat-resistant material, since tests have shown that brushes made of plastic can be impaired by the friction-induced development of heat. Furthermore, as a result of the brushes being provided, it is possible to clean the tool of the power tool, such that, following completion of the work, the tool can be stored in a clean state, or such that complicated and labor-intensive cleaning of the tool once work with the power tool has finished can be dispensed with. As a result, personnel costs and labor costs can advantageously be saved and employees can spend more time doing other jobs.

In another configuration of the invention it is preferred that a gap for receiving a tool of the power tool is introduced into the device only during a work process. This means in particular that a gap for receiving the saw blade or the cut-off wheel is introduced into the covering rail during the work process of the power tool. In this case, the introduction is effected preferably by the tool of the power tool itself. This preferably means, according to the invention, that a prefabricated gap for the saw blade of the saw or the cut-off wheel of the cut-off grinder is not initially provided in the rail. Rather, in this embodiment of the invention, the gap, by way of which the sawing or separating process takes place, is cut into the device during the process. As a result, the configuration of the gap can be adapted particularly well to the specific requirements of the work process. This advantageously allows particularly efficacious and effective dust extraction, as required, by the proposed device, since the gap exists only at the location where the power tool is actually working. In particular, this configuration of the invention allows dust extraction by the dust extraction device that is focused in a highly localized manner on the working area of the power tool. In this preferred configuration of the invention, the covering rail can be sold as a cost-effective disposable product. As a result, it is possible in particular to dispense with aligning the extraction exactly with the cut, thereby allowing quicker and easier mounting of the covering rail. Preferably, a specific cut length is defined shortly before the cut is created. In this regard, the covering rail can, in this preferred configuration of the invention, be adapted on site, for example on a building site, to the specific requirements of the case in question. By way of example, the covering rail can be offered in the form of a bar with a length of for example 3 m, wherein a user can cut the rail or bar to a required length on site.

According to the invention, it is preferred that the proposed covering rail is usable in conjunction with a guide rail for the power tool or is a constituent of such a guide rail. According to the invention, it is preferred that the cut cover is fastened to a guide rail, which is used for example in conjunction with a saw. As a result, the effort for mounting and parallel alignment with the cut can advantageously be considerably reduced. According to the invention, it is preferred that the guide rail is itself a constituent of a guide system. According to the invention, it is very particularly preferred that the proposed covering rail is a constituent of such a guide system. The guide system can for example also comprise feet for the guide rail, wherein these feet can preferably also be referred to as “guide feet”. Guide rails can be used for example in order to allow straight cutting. Advantageously, the invention can be combined with or used together with known guide rails that are known from the prior art. According to the invention, it is very particularly preferred that the covering rail is a constituent of a guide rail. In particular, as a result of the combined use of the covering rail and guide rail, synergistic effects are possible and fewer parts have to be carried along on a building site.

According to the invention, it is preferred that the proposed covering rail also has a cover on its rear side. This configuration of the invention is advantageous particularly when the rail is used together with a saw, wherein the saw is used to cut up an object, for example a component. To this end, it is expedient that the rear side of the covering rail is also equipped with a cover, in order to avoid any escape of dust on the rear side or underside of the covering rail. According to the invention, it is preferred that such a rear-side cover of the device is not penetrated by a tool, for example the saw blade.

It has been shown that the mounting of a covering rail on the rear side is advantageous particularly when, during work with a power tool, which is for example a saw, the substrate to be worked on, the floor to be cut through or the component to be worked on is intended to be cut all the way through. In particular, the provision of the covering rail on the rear side prevents any undesired escape of dust in this region. For the cover, it is possible to use for example a U-profile, which is preferably closed on both sides. Alternatively, it is also possible to stick a film over the rear-side cut region, in order that no dust escapes.

In a second aspect, the invention relates to a system made up of at least two proposed devices. The system is characterized in that the at least two devices are configured to be able to slide one in the other. In other words, the at least two devices can be slid one in the other and preferably be connected together such that they form an extended covering rail. As a result, longer cuts can be produced with the power tool, wherein advantageously effective dust extraction can be ensured even during the creation of these longer cuts by the proposed system.

The terms, definitions and technical advantages introduced for the device apply preferably in an analogous manner to the system and the method described in the following text.

In a further aspect, the invention relates to a method for extracting dust from a working area of a power tool. The method comprises the following steps:
a) providing a device or a system as described above,
b) covering the working area of the power tool with the device or a device of the system,
c) connecting the device or a device of the system to a device for dust extraction,
d) carrying out a work process with the power tool,
d) extracting the dust that arises during the work process with the device for dust extraction.

In the context of the extraction method, it is provided that devices, such as covering rails, are used in order to cover the cutting gap that arises when working with a power tool. The covering of the cutting gap advantageously results in the working area of the power tool being covered, such that the dust that arises when working with the power tool cannot escape from the working area of the power tool but rather is extracted advantageously in situ by the dust extraction device. To this end, the device has, at its ends, means for connecting a dust extraction device. The connection between the device or a device of the system and a dust extraction device can preferably be established with a suction hose, wherein the suction hose can lead into the device at the connection means. A second end of the suction hose is preferably connected to the dust extraction device, such that a particularly dust-tight connection between the covering rail and vacuum cleaner can be established.

According to the invention, it may be preferred that the dust extraction is switched on first, and subsequently the work process with the power tool is started. However, according to the invention, it may also be preferred that the cutting or separating work with the power tool is started first and then the dust extraction is switched on. The dust extraction and/or the power tool can be switched on or off for example manually by a user of the power tool. However, according to the invention, it may also be preferred that the power tool and/or the suction device are configured such that data are exchanged so as to influence the control of the devices. For example, the power tool can transmit data relating to the operation thereof to the vacuuming device, such that the vacuuming device switches on or off automatically on the basis of the received data. As a result, the operation of the suction device can be configured for example such that the suction device is only on when the power tool is also being operated at the same time. As a result, the suction device can advantageously operate particularly as required and in a particularly energy-saving manner. According to the invention, it may also be preferred that the suction device transmits data relating to the operation thereof to the power tool, such that, on the basis of the received data, the power tool sets or regulates its operation accordingly. For example, information received by the vacuuming device can also be displayed on a display device of the power tool. If for example the vacuuming device establishes that its dust filter or dust bag is full, and so it is necessary to change or clean it, the vacuuming device can transmit this information to the power tool and the power tool can display this information for example on a display or screen. According to the invention, it is also preferred that the power tool is automatically capable of interrupting a work process. For example, a wall saw in an automatic mode can automatically interrupt a sawing operation when extraction performance of the vacuuming device weakens. In the context of the invention, it may also be preferred that an optical display means is provided on the power tool, with which the user is provided with the information or the content thereof. For example, a red LED on the power tool can light up when the power tool receives the information that the dust filter or bag of the vacuuming device needs to be changed. The transfer and exchange of data between the power tool and vacuuming device can be unidirectional or bidirectional. Furthermore, it may be preferred that the communication between the power tool and vacuuming device is wired and/or wireless.

### BRIEF DESCRIPTION OF THE DRAWINGS

Further advantages will become apparent from the following description of the figures. The figures, the description and the claims contain numerous features in combination. A person skilled in the art will expediently also consider the features individually and combine them to form useful further combinations.

In the figures, identical and similar components are denoted by the same reference signs. In the figures:

FIG. 1 shows a side view of a preferred configuration of the device

FIG. 2 shows an oblique side view of a preferred configuration of the device

FIG. 3 shows an oblique side view of a preferred configuration of the device

FIG. 4 shows a plan view of a preferred configuration of the device

FIG. 5 shows a further side view of a preferred configuration of the device

### DETAILED DESCRIPTION

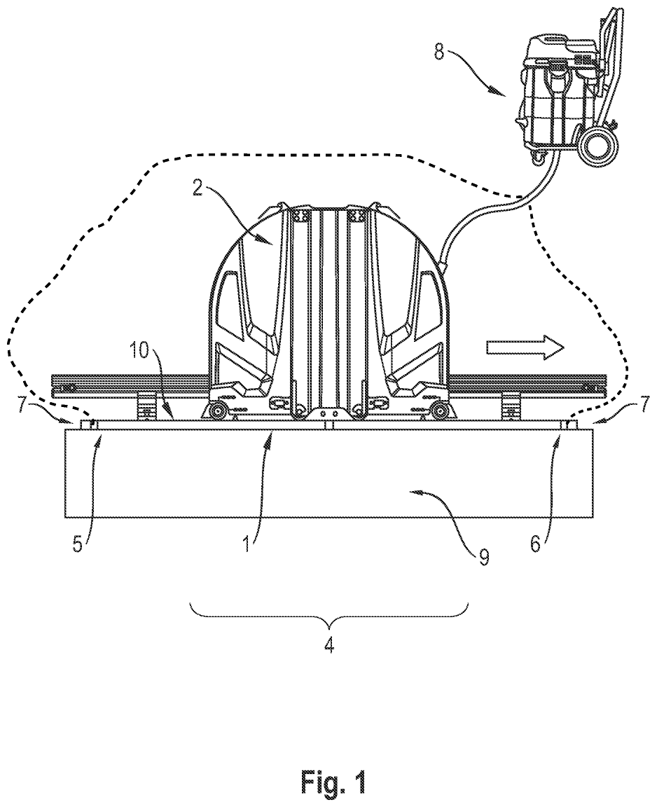

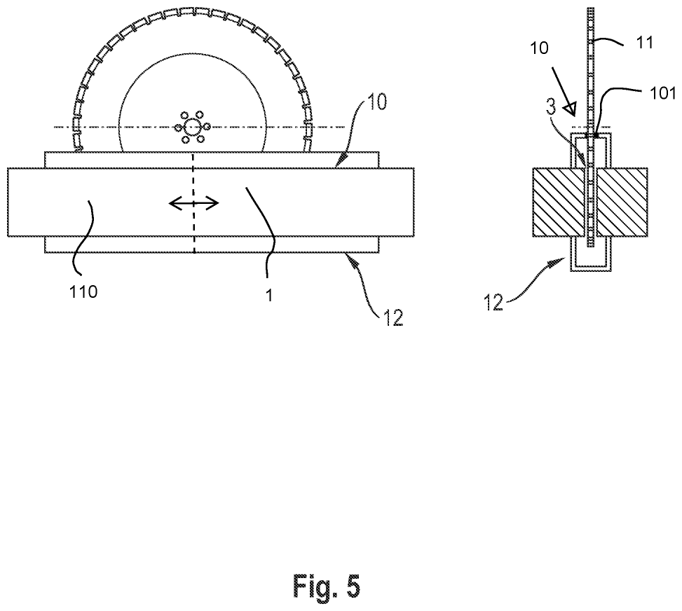

FIG. 1 shows a preferred configuration of a device (1) according to the invention. By way of example, a cut is intended to be introduced into a substrate (9) with the power tool (2, symbolized by the blade guard of the tool), or two regions of the substrate (9) are intended to be separated from one another. The power tool (2) may be for example a saw, in particular a wall saw or a cut-off grinder. The tool (11, see, e.g., FIG. 5) of the power tool (2) may be for example a saw blade or a cut-off wheel, which may preferably be provided with diamond fragments or diamond grains, in order to improve the cutting action. As a result of the cutting or separation with the power tool (2), a cutting gap (3, see, e.g., FIG. 5) is created in the substrate (9), said cutting gap being able to define a working area (4) of the power tool (2) or to coincide therewith. The working area (4) of the power tool (2) is defined preferably by the area in which the tool (11) and the substrate (9) to be worked on are in contact with one another, and by the adjoining spatial areas that extend preferably in a “forward” spatial direction and a “rearward” spatial direction. The contact area between the tool (11) and substrate (9) is indicated in FIG. 1 by the marking in the device (1) in the middle of FIG. 1. According to the invention, it may be preferred that the working area (4) coincides with or corresponds to a length of the device (1).

The device (1) is designed to cover the cutting gap (3) such that advantageously a closed dust space arises. This dust space can likewise coincide with the working area (4) of the power tool (2). According to the invention, the device (1) can preferably also be referred to as a covering rail. At the ends (5, 6) of the covering rail (1), closing caps (7) are provided. These closing caps (7) may comprise connection means for connecting to a vacuuming device (8). In particular, it may have extraction nozzles. It may also be configured to press the covering rail (1) onto the substrate (9) to be worked on, in order in this way to seal the dust space in a particularly effective manner. Preferably, in particular a lower region of the closing caps (7) serves to hold down the device (1) while an upper region of the closing cap (7) may comprise an extraction nozzle for connecting to a vacuuming device (8).

According to the invention, it is preferred that the power tool (2) cuts through the substrate (9) or separates different regions of the substrate (9) from one another along the device (1). In this case, the power tool (2) preferably executes a linear or straight movement. The power tool (2) can be moved by a user for example starting from a first end (5) of the covering rail (1) in the direction of a second end (6) of the covering rail (1). This forward movement of the power tool (2) is indicated in FIG. 1 by the arrow in the right-hand half of the image. In this regard, the first end (5) of the device can preferably also be referred to as the rear end (5) of the covering rail (1), while the second end (6) of the device (1) can preferably also be referred to as the front end (6) of the covering rail (1).

The power tool (2) can be connected to a vacuuming device (8). For example, an extraction nozzle can be provided at the blade guard that protects the tool (11) of the power tool (2). Between this extraction nozzle of the power tool (2) and the vacuuming device (8), a suction hose may be arranged, through which the extracted dust is transported out of the closed dust space into a dust collecting tank in the vacuuming device (8). The suction hose is indicated in FIG. 1 by a curved connecting line between the power tool (2) and vacuuming device (8).

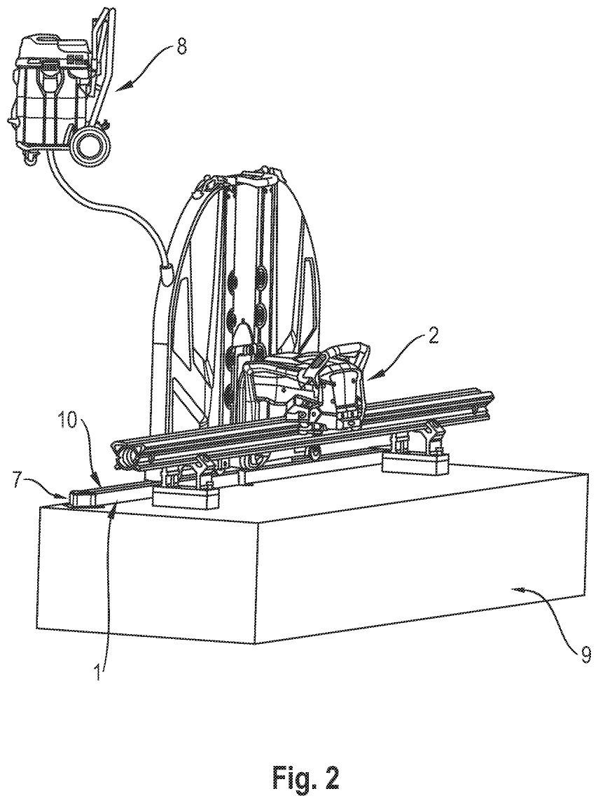

FIG. 2 shows an oblique side view of a preferred configuration of the proposed covering rail (1). The power tool (2), which introduces a cut or a gap into a substrate (9), can be seen in FIG. 2. A cutting gap (3, see, e.g., FIG. 5) is formed thereby. As a result of working with the power tool (2), dust is created, which partially remains in the cutting gap (3) but can also be thrown out of the gap (3). In the context of the present invention, the dust passes into a closed dust space, which is formed by the gap (3) and the covering rail (1). In particular, the covering rail (1) forms an upward boundary of the substantially closed dust space. At the sides, i.e. at the ends (5, 6) of the covering rail (1) there are closing caps (7), which are designed to seal the dust space in a “forward” spatial direction and in a “rearward” spatial direction. The closing caps (7) can each have an extraction nozzle, in order to be connected to a vacuuming device (8). This connection is illustrated solely schematically in FIG. 1, and the presence thereof is highly preferred according to the invention. Furthermore, a lower region of the closing caps (7) can act as a holding-down means and press the covering rail (1) onto the substrate (9) to be worked on. As a result, the dust-tightness of the closed dust space is further increased and advantageously prevents dust escaping from the dust space and being able to get into the airways of a user of the power tool (2).

The power tool (2), or the blade guard of the tool (11) of the power tool (2), can be connected to a vacuuming device (8) using a suction hose. The tool (11) of the power tool (2) penetrates through a working gap (10) into the substantially closed dust space. The gap (10) may be provided in a prefabricated manner in the covering rail (1). According to the invention, it may also be preferred that the gap (10) is introduced into the covering rail (1) only by the power tool (2) itself. In the case of a prefabricated gap (10), brushes (illustrated schematically as 101 in FIG. 5) may be provided in the gap (10) in order to minimize an exit area for the dust.

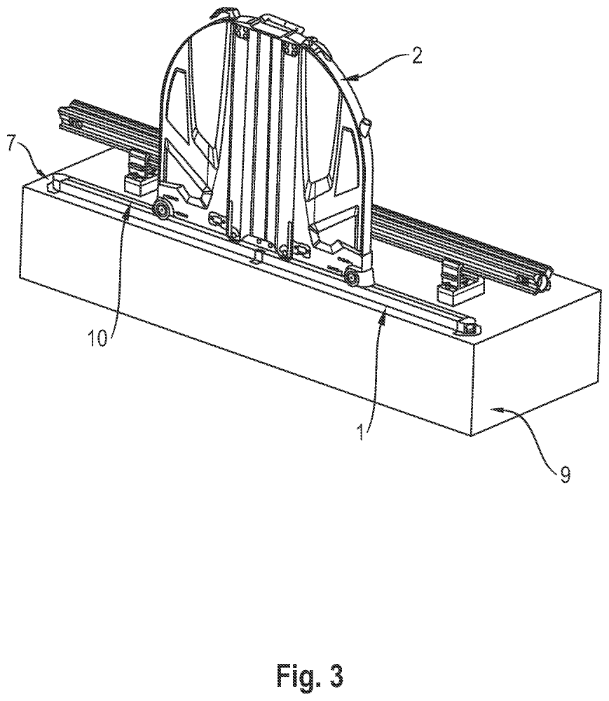

FIG. 3 shows a further oblique side view of a preferred configuration of the proposed covering rail (1). In particular, FIG. 3 shows the substrate (9) into which a cutting gap (3, see, e.g., FIG. 5) is intended to be introduced. To this end, the power tool (2) is moved along a guide rail such that the tool (11, see, e.g., FIG. 5) of the power tool (2) can penetrate into the substrate (9) to be worked on and create the cutting gap (3). According to the invention, it is particularly preferred that the tool (11) of the power tool (2) penetrates through the gap (10) in the device (1) into the preferably closed dust space or into the substrate (9) to be worked on. In the preferred embodiment of the invention that is illustrated in FIG. 3, the closing caps (7) of the device (1) are arranged at the ends of the covering rail (1).

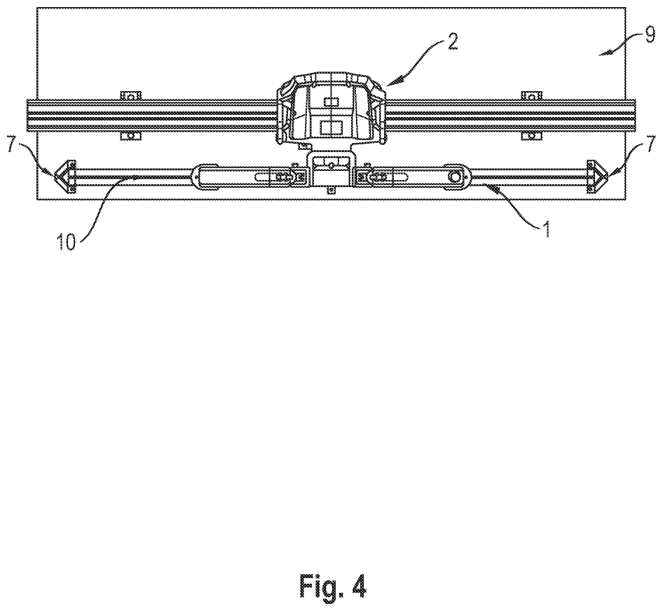

FIG. 4 shows a plan view of a preferred configuration of the device (1). In particular the power tool (2), which can move along a guide rail over the substrate (9) to be worked on, is illustrated. The power tool (2) is designed to set the tool (11), which may particularly preferably be a wall saw, into rotational movement in order to work on a substrate (9). In the exemplary embodiment of the invention that is illustrated in FIG. 4, the covering rail (1) has two closing caps (7), which are arranged at the front end (6) and the rear end (5) of the device (1). The extraction nozzles, which may each be provided on the closing caps (7) in order to establish a connection to a vacuuming device (8), are not illustrated. The device (1) has a gap (10) in which the tool (11) of the power tool (2) can rotate in order the cutting gap (3, see, e.g., FIG. 5) for severing the substrate (9) to be worked on can be created.

FIG. 5 shows a preferred exemplary embodiment of the proposed covering rail (1) in side view, in which two rails 1, 110 are shown solely schematically slidable with respect to each other for example in a telescopic manner. In particular, FIG. 5 shows a rear-side cover (12), which can be used to cover an underside or a rear side of the substrate (9) to be worked on. This is particularly advantageous when a component is intended to be cut to size with the power tool (2), which may be for example a saw, such that the object to be worked on is cut substantially all the way through. The rear-side cover (12) may be for example a U-profile or a film.

### LIST OF REFERENCE SIGNS

1 Device

2 Power tool

3 Cutting gap

4 Working area

5 First end of the device

6 Second end of the device

7 Connection means

8 Vacuuming device

9 Substrate

10 Gap

11 Tool of the power tool

12 Rear-side cover

1-11. (canceled)

12. A device for covering a cutting gap creatable by a power tool, the device comprising:
a section covering the cutting gap in a working area of the power tool, the device including at least one connector for connecting a dust extractor.

13. The device as recited in claim 12 wherein the at least one connector is arranged at one end of the device.

14. The device as recited in claim 12 wherein the at least one connector includes two connectors, each of the two connectors arranged at an end of the device.

15. The device as recited in claim 12 wherein the at least one connector also presses the device onto a substrate to be worked on.

16. The device as recited in claim 12 wherein the at least one connector includes two connectors externally sealing the cutting gap at ends of the cutting gap.

17. The device as recited in claim 12 further comprising a prefabricated gap for receiving a tool of the power tool during a work process.

18. The device as recited in claim 17 further comprising brushes projecting into the prefabricated gap.

19. The device as recited in claim 17 wherein the device is configured in a telescopic manner.

20. The device as recited in claim 12 further comprising a gap for receiving a tool of the power tool, the gap being introduceable into the device during a work process.

21. A guide system comprising the device as recited in claim 12 and a guide rail for the power tool.

22. A method for operating the device as recited in claim 12 comprising:
using the device during a dry application of the power tool.

23. A system made up of at least two devices each as recited in claim 12, the at least two devices capable of sliding one in the other.

24. A method for extracting dust from a working area of a power tool, the method comprising the following steps:
a) providing the device as recited in claim 12;
b) covering the working area with the device;
c) connecting the device to the dust extractor;
d) carrying out a work process with the power tool; and
d) extracting dust arising during the work process with the dust extractor.
